(19) United States
(12) Patent Application Publication
(10) Pub. No.: US 2021/0361001 A1
(43) Pub. Date: Nov. 25, 2021

(54) BAND FOR FACE MASKS AND OTHER STRUCTURES

(71) Applicant: Gollie Industries, LLC, Pataskala, OH (US)

(72) Inventor: Gloria A. Gandara-Thomas, New Albany, OH (US)

(21) Appl. No.: 17/062,918

(22) Filed: Oct. 5, 2020

Related U.S. Application Data
(60) Provisional application No. 63/029,051, filed on May 22, 2020.

(51) Int. Cl. A41D 13/11; A62B 18/08

(52) U.S. Cl. CPC A41D 13/1161; A62B 18/084

(57) ABSTRACT

An apparatus that enhances the comfortable use of conventional, dual-loop respirators. An elastic strip has first and second fasteners at or near opposing first and second ends and multiple openings that extend entirely through the strip along a path between the first and second fasteners. The first fastener may be inserted through one of the openings forming a first portion of the strip that encircles a first loop of the respirator. The second fastener may be inserted through a different one of the openings while a second portion of the strip encircles the second loop of the respirator. As an alternative, the second loop may simply extend around the second fastener.

### CROSS-REFERENCES TO RELATED APPLICATIONS

This application claims the benefit of U.S. Provisional Application No. 63/029,051 filed May 22, 2020.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to respirators (commonly referred to as “masks”) used to cover the mouths and noses of human wearers, and more specifically to a flexible strip used to aid in the comfort of wearing respirators with elastic loops on opposite sides that are designed to extend around the ears to hold the respirator to the wearer's face.

A respirator is a device designed to protect the wearer from inhaling harmful airborne substances, including fumes, vapors, gases and particulate matter such as dusts and airborne microorganisms. Respirators have a face covering held to the wearer's head with straps, a cloth, or some other means extending rearward (posterior), typically around the rear of the head at least to the ears and, in some embodiments, completely around the head. In a common inexpensive respirator, a piece of dome-shaped filtration media has elastic loops attached at opposite sides, each of which is designed to extend rearwardly around the ears of a human wearer to retain the respirator in place. One example of such a conventional respirator is shown in FIG. 1, and typical configurations of conventional respirators worn by a man and a woman are shown in FIGS. 2 and 3, respectively.

One problem with the loops of conventional respirators is that they hold the respirator to the face by exerting a force to the backs of the ears. Because ears do not commonly have such a force applied to them, after a time of wearing such a mask, the user may notice discomfort in the ears due to the applied force. Furthermore, the tighter the respirator's filtration media fits to the face, which is necessary for a seal that avoids air bypassing the filtration media, the more discomfort the wearer may experience, or the sooner the wearer may experience discomfort.

Alternatives to the loops are used as means of attaching respirators to the human head, and these include straps or other structures that fit around the back of the human head. These can be bands, commonly one around the top of the head (FIG. 4) and one around the middle rear of the head and/or the neck (FIG. 5), or single bands that branch out to encompass the entire crown of the head in addition to a band around the neck. For example, respirator model HF-801SD is sold under the 3M® trademark, and has a single strap that extends around the neck, as well as a single strap that extends around the upper part of the head, and separates into two straps that encircle the crown of the wearer's head.

There are also various straps with different fasteners at each end. Alternative means of fastening respirators to human heads are available, but there is still a need to improve the comfort of the ubiquitous and inexpensive respirator that fastens by extending loops around the ears.

### BRIEF SUMMARY OF THE INVENTION

Disclosed herein is an apparatus that enhances the comfortable use of conventional, dual-loop respirators. The apparatus has a strip with fasteners at its opposing first and second ends. The strip preferably has multiple openings therein into which the fasteners may be inserted to encircle a structure, such as a loop of the respirator. The openings are preferably along at least one line, and there may be multiple lines of openings.

The apparatus attaches to the loops of the respirators, which may be conventional elastic loops that are designed to go around a user's ears, or may be any other loops to which the apparatus may attach, as described herein. The strip is preferably elastic material that may be stretched lengthwise between the loops. The elasticity permits the user to apply a rearward force to the loops to cause the desired amount of tension on the face of the user.

Disclosed herein is an apparatus that may be attached to a respirator having a filtration media with first and second loops at opposing respirator sides. The apparatus comprises an elongated strip that is elastically deformable in at least its length. A first fastener is mounted to the strip near a first strip end and a second fastener is mounted to the strip near a second, opposing strip end. A plurality of openings is formed through the strip extending along a path between the first and second fasteners. Each of the plurality of openings is configured to receive at least one of the fasteners therethrough, and each of the fasteners is configured to extend around one of the loops of the respirator.

In some embodiments, at least one of the fasteners is a button, which may be circular or elongated, and in some embodiments the fastener is a hook. In some embodiments, the elongated strip has a first major surface and an opposing, second major surface, and the first fastener is mounted to the first major surface and the second fastener is mounted to the second major surface. In some embodiments, the elongated strip has a first major surface and an opposing, second major surface, and the first and second fasteners are mounted to the first major surface.

In some embodiments, a second elongated strip that is elastically deformable in at least its length has a third fastener mounted to the second strip near the second strip's first end and a fourth fastener mounted to the second strip near the second strip's opposing second end. A second plurality of openings is formed through the second strip along a path extending between the third and fourth fasteners. At least one of the fasteners of one of the strips has extended through at least one of the openings of the other strip.

Disclosed herein is an apparatus combined with a respirator having a filtration media with first and second loops at opposing respirator sides. The combination comprises an elongated strip that is elastically deformable in at least its length and has opposed first and second ends. A first fastener is mounted to the strip near the first end and a second fastener is mounted to the strip near the second end. A plurality of openings is formed through the strip extending along a path between the first and second fasteners. The first fastener extends through one of the plurality of openings, and a part of the strip thereby encircles the first loop, and the second end of the strip is fastened to the second loop.

In some embodiments, the second fastener extends around the second loop. In some embodiments the second fastener extends through another of the plurality of openings and a part of the strip encircles the second loop. In some embodiments, a second elongated strip is elastically deformable in at least its length, and has a third fastener mounted to the second strip near the second strip's first end. A fourth fastener is mounted to the second strip near the second strip's opposing second end. A second plurality of openings is formed through the second strip along a path extending between the third and fourth fasteners. The second strip's first end is fastened to the first loop, and the second strip's second end is fastened to the second loop.

Disclosed herein is a method of using a respirator having a filtration media with first and second loops at opposing respirator sides. The method comprises fastening to the first loop a first end of an elongated strip, which strip is elastically deformable in at least its length, by inserting a first fastener through one of a plurality of openings. The plurality of openings is formed through the strip and extends in a path between the first and second fasteners. A first portion of the strip thereby encircles the first loop. A second, opposing end of the elongated strip is fastened to the second loop by a second fastener on the second end.

In some embodiments, the step of fastening to the second loop comprises the second loop extending around the second fastener. In some embodiments, the step of fastening to the second loop comprises the second fastener inserting through a second one of a plurality of openings, a second portion of the strip thereby encircling the second loop.

In some embodiments, the method further comprises fastening to the first loop a first end of a second elongated strip, which second strip is elastically deformable in at least its length. In some embodiments, the method further comprises fastening to the second loop a second, opposing end of the second strip. The second end has a fourth fastener and a plurality of openings that is formed through the second strip and extends in a path between the third and fourth fasteners.

### BRIEF DESCRIPTION OF THE SEVERAL VIEWS OF THE DRAWINGS

FIG. 1 is a front view illustrating a conventional respirator.

FIG. 2 is a side view illustrating a conventional respirator mounted in a conventional way on a male user.

FIG. 3 is a side view illustrating a conventional respirator mounted in a conventional way on a female user.

FIG. 4 is a side view illustrating a conventional respirator mounted in a conventional way on a user.

FIG. 5 is a side view illustrating a conventional respirator mounted in a conventional way on a user.

FIG. 6 is a top view illustrating an embodiment of the invention.

FIG. 7 is a side view illustrating the embodiment of FIG. 6.

FIG. 8 is a side view illustrating the embodiment of FIG. 6 mounted to loops of a respirator.

FIG. 9 is a rear view illustrating an embodiment of the invention mounted to a human head.

FIG. 10 is a side view illustrating an embodiment of the invention mounted to a human head.

FIG. 11 is a rear view illustrating an embodiment of the invention mounted to a human head.

FIG. 12 is a side view illustrating an embodiment of the invention mounted to a human head.

FIG. 13 is a rear view illustrating an embodiment of the invention mounted to a human head.

FIG. 14 is a rear view illustrating an embodiment of the invention mounted to a human head.

FIG. 15 is a top view illustrating an embodiment of the invention in combination with another embodiment of the invention.

FIG. 16 is a side view illustrating the embodiment of FIG. 15.

FIG. 17 is a side schematic view illustrating a plurality of locations of an embodiment of the invention on a human head.

FIG. 18 is a rear view illustrating an embodiment of the invention mounted to a human head.

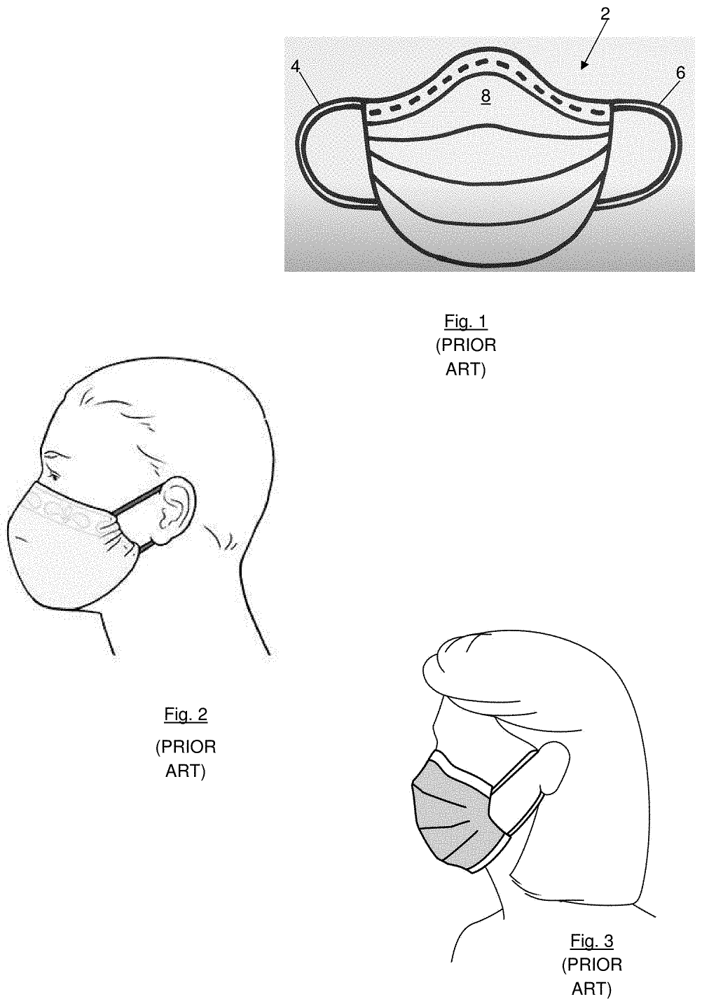

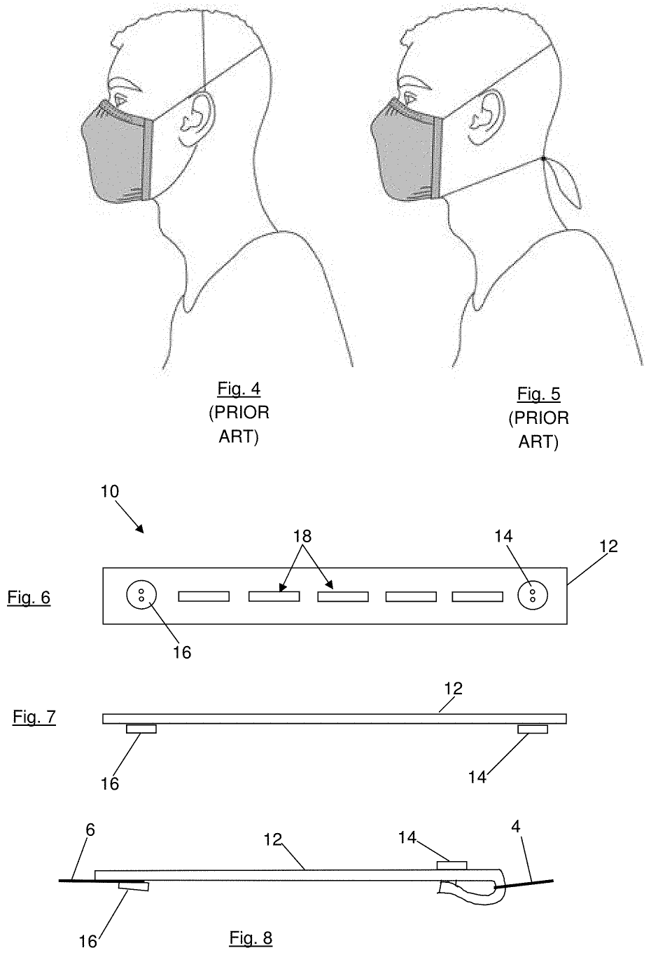

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application Ser. No. 63/029,051 filed May 22, 2020, which is the above-claimed priority application, is incorporated in this application by reference.

FIG. 6 shows an apparatus 10 including an elongated strip 12 having a first fastener, which may be the button 14, sewed, adhered or otherwise affixed near one end of the strip 12. A second fastener, which may be the button 16, is sewed, adhered or otherwise affixed near the opposite end of the strip 12. As shown in FIG. 7, the buttons 14 and 16 are mounted to the same major surface of the strip 12, but it is contemplated to mount the buttons to opposite major surfaces in order to produce advantages that will be apparent to the person having ordinary skill.

The strip 12 is preferably an elastic material, and may be entirely elastic, such as rubber, polyurethane, natural rubber, synthetic rubber, nitrile rubber, silicone rubber, urethane rubbers, chloroprene rubber, Ethylene Vinyl Acetate (EVA rubber) or any other elastomer. It is contemplated to use elastic materials within a textile, a sheath or a coating. A strip is considered elastic if it elongates, when a sufficient longitudinal tensile force is applied, to a length that is greater than its length when in a resting state, and returns to its resting state length upon release of the tensile force. A force sufficient to elongate an elastic material should be easily generated by a human, and could range in quantity from a few ounces to two pounds or more.

The strip 12 has a plurality of openings 18 extending along a line between the buttons 14 and 16. In one embodiment, the strip 12 may be made of buttonhole elastic, which is known in the fashion industry as a fabric with elastic woven or otherwise incorporated therein, and apertures formed along its length. Buttonhole elastic is readily available commercially. The elastic nature of buttonhole elastic permits buttons slightly larger than the holes to be inserted through the holes by expanding to the size of the buttons under the force of button insertion and then contracting when the button has passed through the hole. Other materials are contemplated for the strip 12, and may have openings spaced farther apart or closer together and/or openings that are larger or smaller than conventional buttonhole elastic. One example is a strip made entirely of an elastomeric material, such as polyurethane, which has openings formed therein. Any material used for the strip must not only be elastic, but must not tear when elongated or when a fastener is inserted in one of the openings thereof.

In order to affix the strip 12 to a respirator to improve comfort in the wearing of the respirator, such as the mask 2 shown in FIG. 1, the loops 4 and 6 of the mask 2 are placed in the vicinity of the apparatus 10, such as with opposite ends of the strip 12 adjacent respective loops 4 and 6. After one end of the strip 12 is extended around a loop, such as the loop 4, the fastener on that end, which may be the button 14, may be inserted through one of the openings 18. This thereby fastens one end of the apparatus 10 to the loop 4 as shown in FIG. 8. For example, the button 14 may be inserted through the first, second, third or other opening 18 closest to the button 14, thereby encircling the loop 4 and fastening thereto in a manner that is not released without deliberate action by the user or more force than is normally applied to the apparatus 10 during use.

The opposite end of the strip 12 may be similarly extended around the loop 6 and the button 16 may be inserted through one of the openings 18 to encircle the loop 6 (not shown). This would fix the apparatus 10 to the mask 2 in a “permanent” fashion, meaning the apparatus 10 remains connected to the mask 2 until the user or another person deliberately removes the apparatus 10, such as by removing one or both of the buttons 14 and 16 from their respective openings. Similar attachments at both ends of the apparatus 10 are contemplated.

As an alternative manner of fixing the end to the respirator, the loop 6 may be extended around the button 16, as shown in FIG. 8 without the strip 12 encircling the loop 6, and without the button 16 extending through one of the openings 18. This results in the loop 6 material being positioned between the button 16 and the strip 12, and, when the elastic strip 12 is under tension, there is typically sufficient resistance to the button 16 being moved that the loop 6 would not unintentionally be removed from the button 16 during use. When not under tension, such as when the mask is not being worn, the button 16 and the loop 6 may unintentionally separate, which is essentially impossible with a permanent attachment. However, by manually withdrawing the loop 6 from under the button 16, a wearer may readily remove the loop 6 intentionally. This attachment is referred to as a “temporary” attachment, because it is more likely to detach without deliberate action by a human, even though attachment is typically maintained when the mask is being worn by a person. A temporary attachment may also be more easily engaged than a permanent attachment, which makes it more convenient under some circumstances, and therefore it remains an option for a user to select. One or both of the loops 4 and 6 may be extended around the buttons 14 and 16, respectively, instead of encircling the loop 4 or the loop 6 with the strip 12 as shown in FIG. 8 on the right end.

When a loop is encircled by a buttoned-down end of the strip 12 as shown in FIG. 8 at the right end, then the apparatus 10 is fixed to the respirator 2 in a “permanent” manner so that when the respirator is removed from the wearer, the apparatus 10 stays attached to at least the encircled loop. When a loop extends directly around the button, such as with the button 16 shown by the example in FIG. 8 at the left end, this is considered a “temporary” attachment because the loop may be more readily removed from the apparatus 10 than when the loop is encircled. Removal of the loop from attachment to the apparatus 10 in the temporary example only requires manually lifting of the loop away from the button, or vice versa. However, when the strip 12 encircles a loop and a button is extended through an opening is a permanent attachment, the button or other fastener must be removed from the opening in order for the loop to be removed from the apparatus 10. Each manner of fastening may be more desirable in different circumstances.

It is contemplated that one loop of a respirator may be in a temporary attachment, while at the opposite end of the apparatus 10 loop is encircled and the button is extended through an opening in a permanent attachment. With the permanent attachment, one end of the apparatus 10 remains attached to the respirator until complete removal is desired, at which time the user unbuttons the apparatus 10. In the meantime, however, the end of the apparatus 10 with the temporary attachment may be readily attached to the loop 6 by extending the loop 6 around the button 16 as shown in FIG. 8, and detached from the loop 6 by reversing this action. This configuration makes installation on, and removal from, the wearer quick and convenient in addition to retaining the apparatus 10 on the mask 2 at all times so it is not lost. Thus, both ends of the apparatus may encircle the opposing loops 4 and 6, both loops 4 and 6 may extend around a respective button, or one end may encircle and the opposite end may have the opposing loop extend around a button or other fastener. Therefore, the apparatus 10 provides extensive flexibility in use.

It should be noted that, although the elastic loops 4 and 6 on a conventional respirator mask 2 may be used for attachment of the apparatus 10, a respirator with any type of loop may be used with the apparatus 10, even if the respirator has a type of loop that is different from those shown or described herein. In this disclosure, a “loop” is defined as any structure to which the apparatus 10 may attach by encircling material and fastening, as shown at the right end of FIG. 8, or the fastener fixing directly to, as shown by the left end of FIG. 8. Thus, a loop may be an opening in the filtration media of which the respirator is formed, because a part of the filtration material may be extended around a fastener, such as the button 16, and a portion of the strip may encircle that part. Alternatively, a loop may be a small piece of material that protrudes from a respirator. Still further, a loop may be a staple or other structure attached to the respirator material that extends sufficiently for attachment. All of these structures are considered “loops” for the purposes of the invention.

The buttons 14 and 16 are but one type of contemplated fasteners. Sewing hooks, elongated rods and other fasteners are contemplated to affix an end of the strip 12 to a loop on a respirator. This can be accomplished by extending around the loop and then fastening through an opening 18, or such fasteners may simply fasten to a corresponding loop by the loop extending around the fastener, in the manner of a hook that is substituted for the button 16 of FIG. 8. Each of the loops of a conventional respirator may thus be fixed to a corresponding end of an apparatus 10 by the loop extending around the fastener, or by the user encircling an end of the strip 12 around the loop and inserting the fastener through an opening.

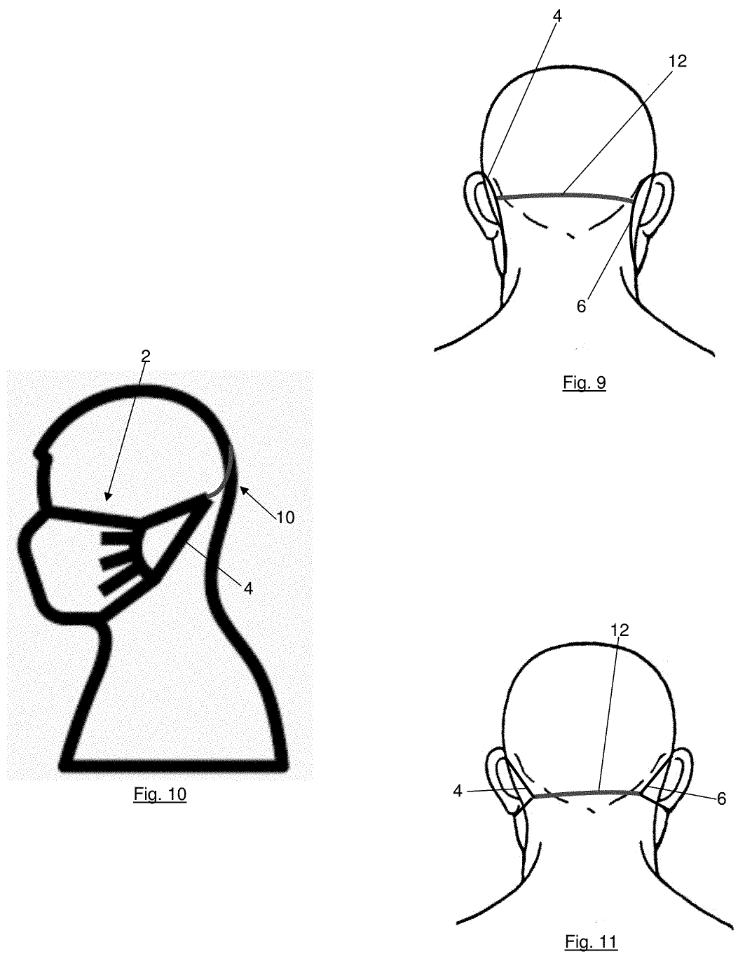

It is contemplated to use a single apparatus 10 on a human wearer, and such an apparatus 10 may extend from attachment to one respirator loop around the back of the head to attachment to the other respirator loop, as shown in FIGS. 9-11. The apparatus 10 may apply varying degrees of tension to the loops in different configurations, and this is accomplished by adjusting the length of the apparatus 10 (for example, by inserting fasteners into different openings). The configurations shown in FIGS. 9-11 prevent the loops 4 and 6 from applying significant pressure to the backs of the ears when placed in their conventional positions over or around the ears by either extending the loops over the ears, or by applying sufficient tension to the loops so that the loops apply little or no force to the ears.

For example, FIG. 9 shows the apparatus 10 attached to the loops 4 and 6 with very little tension so that the loops 4 and 6 extend around the ears of the wearer loosely (note the arcuate shape of the loops 4 and 6). As an alternative, when the apparatus 10 is attached in the same way to the loops, but pulls more tightly on the loops 4 and 6 as shown in FIGS. 10 and 11, the loops 4 and 6 may extend over the ears entirely (see FIG. 10) or around the ears (FIG. 11). With more tension, the apparatus 10 may also or alternatively draw the filtration material of the respirator 2 more tightly around the mouth and nose, thereby creating a better seal between the respirator 2 and the wearer's face. Nevertheless, because the apparatus 10 has numerous ways of fastening to the loops, and because there are numerous openings 18 on the strip 12, the wearer may adjust the tension applied to the loops by the apparatus 10.

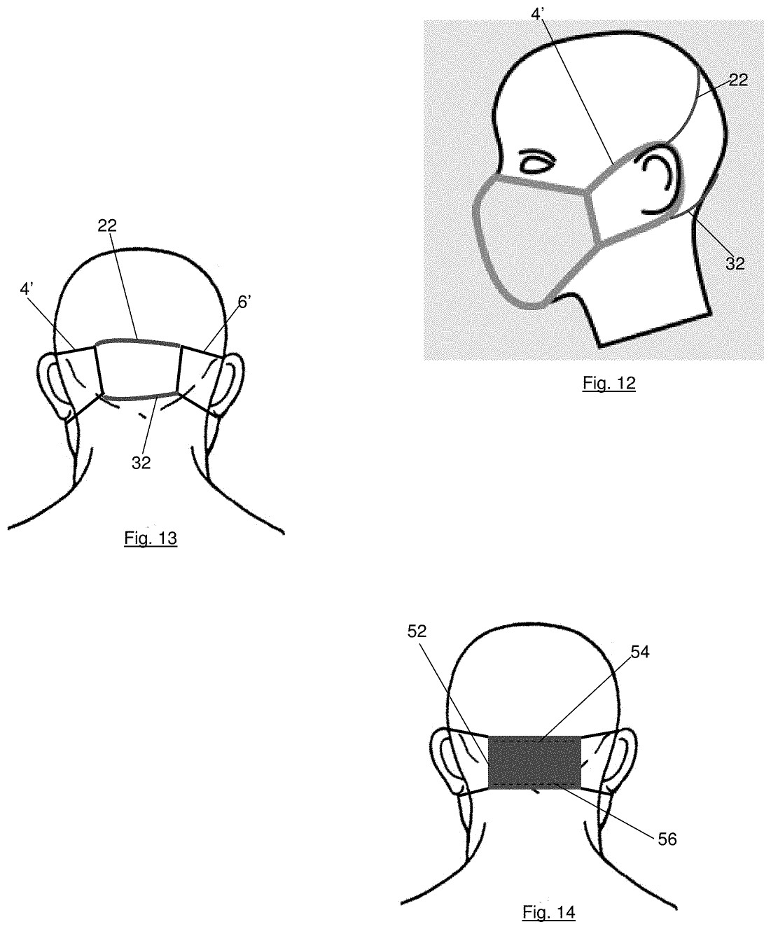

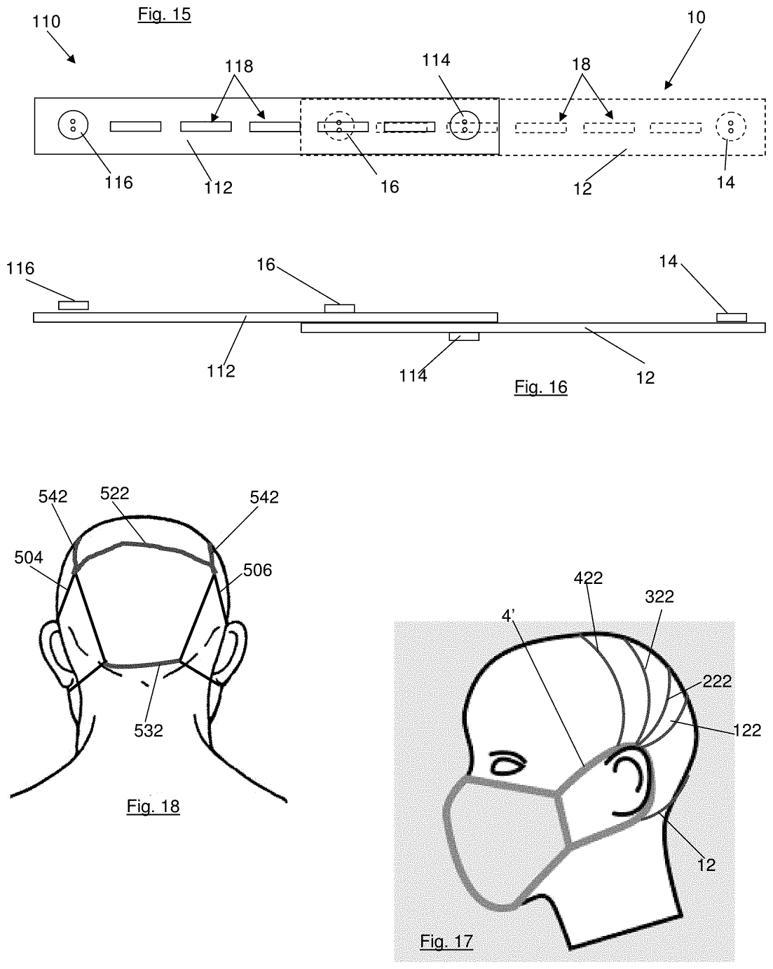

As an alternative manner of attachment shown in FIGS. 12 and 13, it is contemplated to use a first apparatus 32 attached to the loops 4′ and 6′ and that extends around the back of the neck in a lower position. A second apparatus 22 attaches to the portions of the loops 4′ and 6′ that extend around the back of the head in a higher position. In this configuration, the top and bottom apparatuses 22 and 32, respectively, are similar or identical to the apparatus 10, and may pull the loops around the ears so the loops 4′ and 6′ touch the ears lightly (see FIG. 12) or may be adjusted so the loops do not even touch the ears (see FIG. 13). Such a configuration prevents any discomfort to the ears by the conventional loop attachment. Furthermore, the configuration shown in FIGS. 12 and 13 may also reduce the pressure applied to the nose and/or the chin by the top and bottom edges of the filtration media because the loops are pulled by the apparatus 22 and the apparatus 32 in directions that influence the seals, and are arranged in parallel fashion. This seals the respirator well to the face of the wearer and thereby avoids or mitigates air bypass between the filtration media and the wearer. Each of the apparatuses 22 and 32 may be mounted to the loops 4′ and 6′ in any of the manners described for the apparatus 10 above or others that will become apparent to the person of ordinary skill.

It is contemplated that the strip 12 of the apparatus 10 is about one-half inch wide, but the strip could be any width that is sufficient to include openings through which a fastener can be extended. For example, a contemplated strip may be one-eighth inch, one-quarter inch, three-quarters inch or one inch wide. Another strip may be two or three inches wide. Any width that may be used on the rear of a human head is contemplated.

The length of the apparatus 10 is in a range from about three inches to about 18 inches, with one embodiment being five inches, another being six inches, another being seven inches, another being eight inches, another being nine inches, another being ten inches, another being eleven inches and another being twelve inches. Size may be varied according to the age and size of the wearer.

A wider strip may have more than one fastener at each end, and more than one longitudinally-aligned row of openings through which the fastener may extend. For example, a two inch wide strip 52 shown in FIG. 14 (width is in the vertical direction in FIG. 14) that is rectangular may have buttons, hooks or any other fastener near each of the four corners, along with a row of openings 54 extending from the fastener at one top (in the orientation of FIG. 14) corner to the fastener at the opposite top corner. This strip 52 may have a second row of openings 56 that extend from the fastener at one lower corner to the fastener at the opposite lower corner. Apparatuses are contemplated that have three fasteners with three corresponding row of openings.

The apparatus 10 may be used alone as shown in some embodiments herein (e.g., see FIGS. 9-11 and 14), or it may be used with one or more other, similar apparatuses, as shown in FIGS. 12-13. As shown in FIGS. 12-13, the apparatus 10 may be used “in parallel” with one or more other similar or identical apparatuses. Although the apparatuses may not be exactly parallel, they are considered “in parallel” inasmuch as they are aligned next to one another and span a gap between opposite sides of the same mask.

It is also contemplated to use the apparatus 10 “in series” with other similar apparatuses, as shown in FIG. 15, by connecting them together resulting in a longer combination than either of its components. The apparatus 110 is similar to the apparatus 10 and not all similarities will be described herein. The apparatus 110 has some differences from the apparatus 10, such as that its buttons 116 and 114 mounted at opposite ends are on opposite major surfaces of the strip 112 rather than the same. The apparatus 110 may be disposed over the apparatus 10, as shown in FIG. 15 (the apparatus 10 is shown in dashed lines to represent it being beneath the apparatus 110), with the button 16 extending toward the viewer through an opening 118 in the strip 112, and the button 114 extending away from the viewer through the opening 18 in the strip 12. This combination has an overall length greater than the apparatus 10, and the combination may be attached to a mask in the same manner as the apparatus 10 is described above being attached to a mask, with any differences being understood by the person having ordinary skill. The combination may be adjusted to a different length by the user, such as by removing the buttons 16 and 114 from the openings 18 and 118 and inserting them through different openings. It is contemplated that as many such apparatuses may be combined together as is desired to reach a desired total length. Furthermore, other apparatuses that are similar or identical to the apparatuses 10 and/or 110 may be attached to, and positioned transverse or perpendicular to, the apparatuses 10 and 110 to form a desired configuration for the wearer of the respirator for which the combination is constructed.

A wearer may extend the apparatus 10 over the hair of the wearer, as may be typical for males or wearers with short hair. A wearer may alternatively extend the apparatus 10 under the hair, as may be typical for females or wearers with longer hair. As will be understood by all wearers, the apparatus may be removably attached at one end to a loop of a respirator, extended over or under or through the hair, and fixed to the opposite loop.

There is a broad spectrum of locations where the apparatus may be located on a human head, and many of the factors that determine the ideal location depend on head shape and size, along with comfort and activity while the respirator being worn. Therefore, as shown in FIG. 17, a strip 122 of an apparatus similar to the apparatus 10 may be mounted around the middle of the rear of the head. Alternatively, a strip 222 of an apparatus similar to the apparatus 10 may be mounted slightly higher on the rear of the head. Alternatively, a strip 322 of an apparatus similar to the apparatus 10 may be mounted even higher on the rear of the head. Alternatively, a strip 422 of an apparatus similar to the apparatus 10 may be mounted near the top of the head. The strip 12 of the apparatus 10 may be mounted at any point along the rear or top of the head that is feasible, particularly when the apparatus 10 is combined with a similar apparatus lower on the head, such as on or near the neck.

Another contemplated configuration is shown in FIG. 18 in which the loops 504 and 506 extend from a respirator (not visible) that is similar to the respirator 2 shown in FIG. 1. The apparatuses 522, 532 and 542 are identical to the apparatus 10. The combination of the apparatuses 522 and 542 includes the attachment of the buttons of the apparatus 522 to the loops 504 and 506 closer to the crown of the wearer's head than the apparatus 532. The buttons at the ends of the apparatus 542 are inserted in openings in the apparatus 522, and the apparatus 542 extends over the top of the head. This results in a configuration in which the apparatuses 522 and 542 encircle the crown of the wearer's head and pull the loops 504 and 506 upwardly away from the neck. Simultaneously, the apparatus 532 pulls the loops 504 and 506 back toward the neck. Many other configurations are possible, but not all can be described.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus combined with a respirator having a filtration media with first and second loops at opposing respirator sides, the apparatus comprising:
(a) an elongated strip that is elastically deformable in at least the elongated strip's length;
(b) a first fastener mounted to the elongated strip near a first strip end;
(c) a second fastener mounted to the elongated strip near a second, opposing strip end; and
(d) a plurality of openings formed through the elongated strip extending along a path between the first and second fasteners, wherein the openings are aligned with the length of the elongated strip, wherein each of the plurality of openings is configured to receive at least one of the fasteners therethrough and each of the fasteners is configured to extend around one of the loops of the respirator, wherein the first fastener extends through one of the plurality of openings, a part of the elongated strip thereby encircling the first loop.

2. The apparatus in accordance with claim 1, wherein at least one of the fasteners is a button.

3. The apparatus in accordance with claim 1, wherein the elongated strip has a first major surface and an opposing, second major surface, and the first fastener is mounted to the first major surface and the second fastener is mounted to the second major surface.

4. The apparatus in accordance with claim 1, wherein the elongated strip has a first major surface and an opposing, second major surface, and the first and second fasteners are mounted to the first major surface.

5. The apparatus in accordance with claim 1, further comprising:
(a) a second elongated strip that is elastically deformable in at least the second strip's length;
(b) a third fastener mounted to the second strip near the second strip's first end;
(c) a fourth fastener mounted to the second strip near the second strip's opposing second end; and
(d) a second plurality of openings formed through the second strip along a path extending between the third and fourth fasteners, wherein at least one of the fasteners of one of the first and second elongated strips has extended through at least one of the openings of the other elongated strip.

6. An apparatus combined with a respirator having a filtration media with first and second loops at opposing respirator sides, the combination comprising:
(a) an elongated strip that is elastically deformable in at least the elongated strip's length and has opposed first and second ends;
(b) a first fastener mounted to the elongated strip near the first end;
(c) a second fastener mounted to the elongated strip near the second end; and
(d) a plurality of openings formed through the elongated strip extending along a path between the first and second fasteners, wherein the first fastener extends through one of the plurality of openings, a part of the elongated strip thereby encircling the first loop, and the second end of the elongated strip is fastened to the second loop.

7. The apparatus in accordance with claim 6, wherein the second fastener extends around the second loop.

8. The apparatus in accordance with claim 6, wherein the second fastener extends through another of the plurality of openings and a part of the elongated strip encircles the second loop.

9. The apparatus in accordance with claim 6, further comprising:
(a) a second elongated strip that is elastically deformable in at least the second strip's length;
(b) a third fastener mounted to the second strip near the second strip's first end;
(c) a fourth fastener mounted to the second strip near the second strip's opposing second end; and
(d) a second plurality of openings formed through the second strip along a path extending between the third and fourth fasteners, wherein the second strip's first end is fastened to the first loop, and the second strip's second end is fastened to the second loop.

10. A method of using a respirator having a filtration media with first and second loops at opposing respirator sides, the method comprising:
(a) fastening to the first loop a first end of an elongated strip, which elongated strip is elastically deformable in at least the elongated strip's length, by inserting a first fastener through one of a plurality of openings that is formed through the elongated strip and extends in a path between the first and second fasteners, a first portion of the elongated strip thereby encircling the first loop; and
(b) fastening to the second loop a second, opposing end of the elongated strip, the second end having a second fastener.

11. The method in accordance with claim 10, wherein the step of fastening to the second loop comprises the second loop extending around the second fastener.

12. The method in accordance with claim 10, wherein the step of fastening to the second loop comprises the second fastener inserting through a second one of a plurality of openings, a second portion of the elongated strip thereby encircling the second loop.

13. The method in accordance with claim 10, further comprising:
(a) fastening to the first loop a first end of a second elongated strip, which second strip is elastically deformable in at least the second elongated strip's length; and
(b) fastening to the second loop a second, opposing end of the second strip, the second end having a fourth fastener and a plurality of openings that is formed through the second strip and extends in a path between the third and fourth fasteners.
